(19) United States
(12) Patent Application Publication
(10) Pub. No.: US 2003/0155775 A1
(43) Pub. Date: Aug. 21, 2003

(54) Ocean wave energy generation apparatus

(76) Inventor: William Robert Camp, Atlanta, GA (US)

Correspondence Address: William R. Camp, MD, Suite 502, 75 Piedmont Ave, Atlanta, GA, 30303, US

(21) Appl. No.: 10/337,634

(22) Filed: Mar. 26, 2003

Related U.S. Application Data
(60) Provisional application No. 60/345,487, filed on Jan. 7, 2002.

(51) Int. Cl. H02P 9/04; F03B 13/10; F03B 13/12

(52) U.S. Cl. 290/53

(57) ABSTRACT

This device consist of a float which moves up and down in response to the varying depths of ocean water which is caused by Tidal waves plus incidential waves and swells. It forces air into a tank compressing the air in the tank. The tank is mounted on a rod attached to the base. The float moves up and down on the rod.

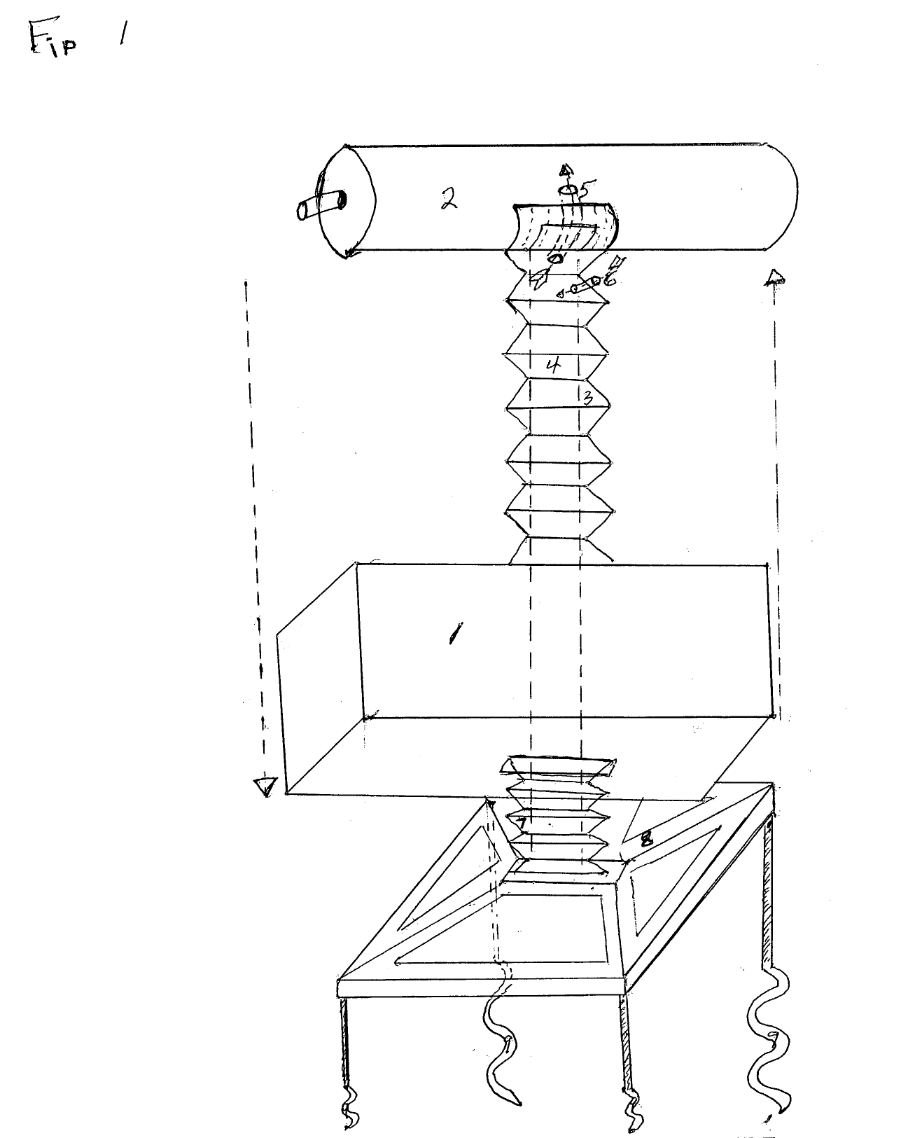

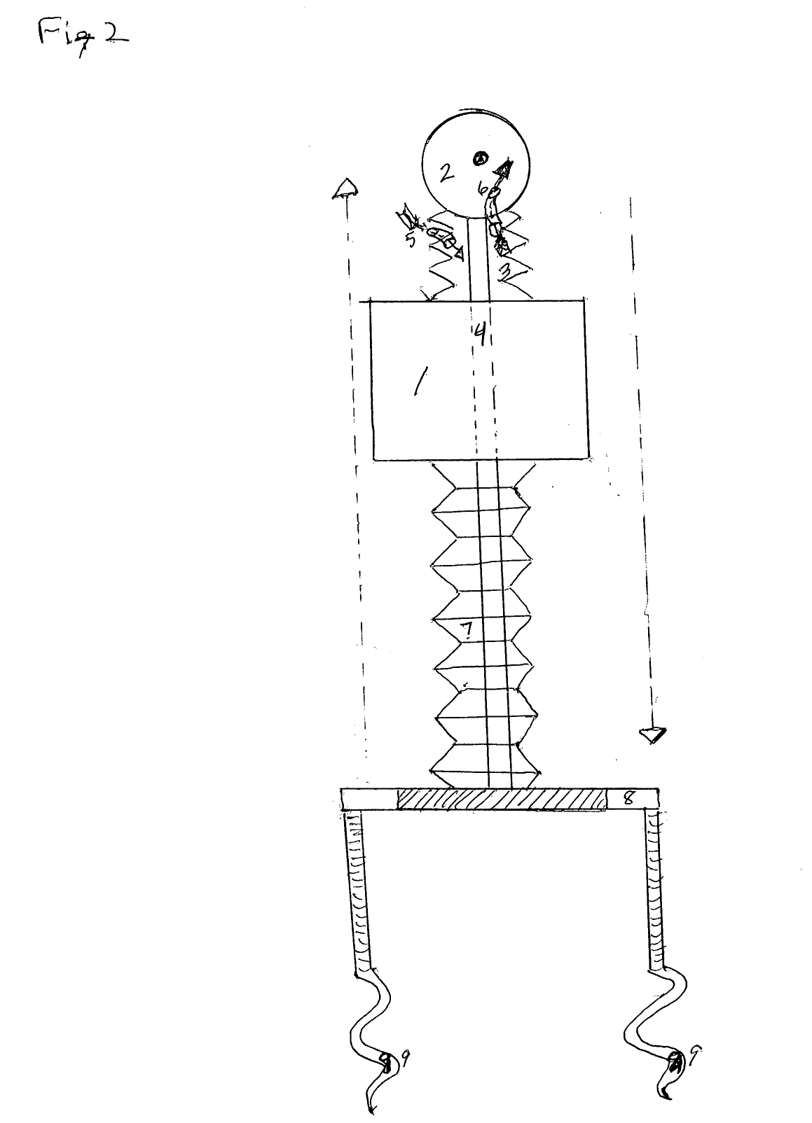

FIG. 1 is a perspective view of the invention.

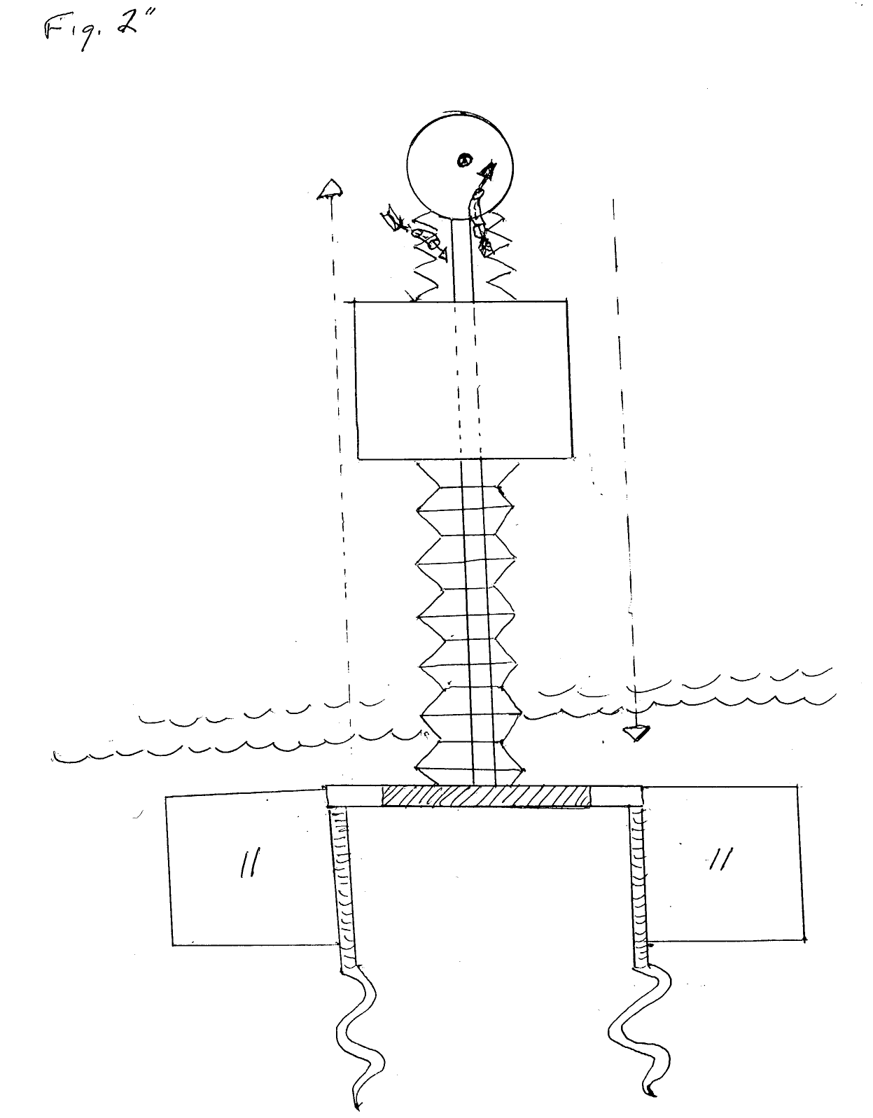

FIG. 2 is an elevational view.

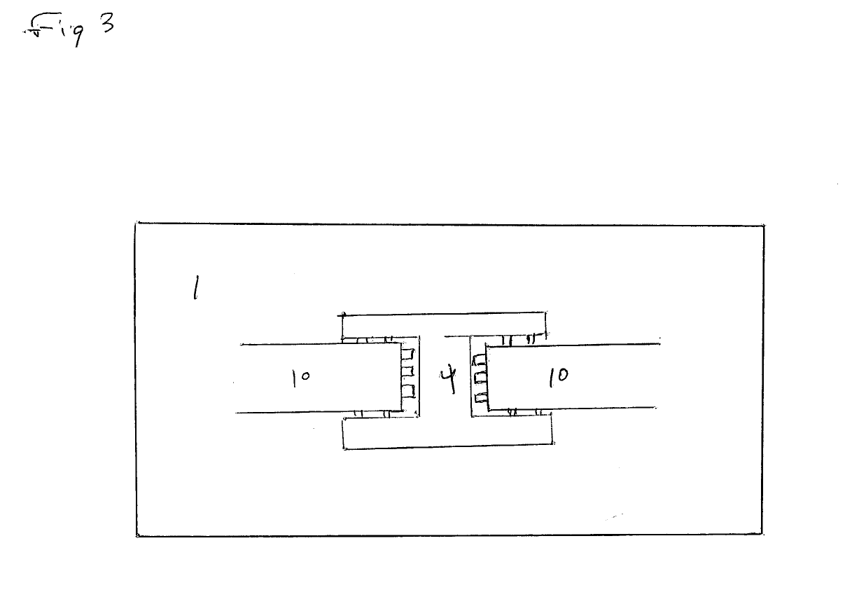

FIG. 3 is an top plan view of the float support and a H shaped rod on which the float moves up and down. Bearings are located on the float.

This machine consists of a 4′×3′×8′ float moves up and down on a rectangler shaped rod via a cam tract with bearings to reduce the friction. It takes advantages of the differences between the depths or varying heights of the surface of the water. Caused by ever present tidal waves plus regular waves and swells.

Each time the float is forced up it packs air into a tank which is attached to the rectangular rod which is attached to the base. The compressed air is then released to run a compressed air motor which in turn rotates an electric turbine which generates electricity.

The base of the machine is attached to cables which are anchored to floor by a drill bit type of device screwed into the ocean floor.

This device would be dispersed in groups of a hundred to a thousand (similiar to cars in a parking lot) located on a common rectangular shaped base.

THIS DEVICE WILL HELP REPLACE HYDROCARBS WITHOUT POLLUTING THE Environment!!!!

It is claimed:

1= a 4′×3′×8′ Float which moves up down in response to surface waves and swells. This is the only moving part of this machine!

2= a tank to contain the compressed air. It opens into an outlet which supplies a compressed air motor which turns an electric turbine.

3= an accordian type of bellows device which forces air into the compressed air tank as it moves upwards.

4= an elongated beam which is attached to the compress air tank and the base. The float moves up and down on this 40 foot long rod.

5= an intake vavle leading to the compressed air tank.

6= an intake vavle which supplies air into the bellows.

7= an accordian type of device which gives enclosure to the section of the rod which is below the float.

8= a base ti which the rod, #4, is attached.

9= a screw or bit type of device which anchors the base, #8. This is located on the ocean floor in deep water with cables leading to the base. The base is located near the surface when the tide is at its lowest position.

10= a rod and bearings attached to the float to enable it to move up and down on the rod, #4.

11= additional floats that hold the device near the surface.
